(19) United States
(12) Patent Application Publication
(10) Pub. No.: US 2025/0172791 A1
(43) Pub. Date: May 29, 2025

(54) METHODS AND DEVICES FOR ADJUSTING AN IMAGE PLANE LOCATION ON AN OFFNER ELAY

(71) Applicant: Applied Materials, Inc., Santa Clara, CA (US)

(72) Inventor: David Arthur MARKLE, Pleasanton, CA (US)

(21) Appl. No.: 18/961,615

(22) Filed: Nov. 27, 2024

Related U.S. Application Data
(60) Provisional application No. 63/603,623, filed on Nov. 28, 2023.

(51) Int. Cl. G02B 17/08

(52) U.S. Cl. CPC G02B 17/0896; G02B 17/0804

(57) ABSTRACT

A method and apparatus for a device, including an object position mirror capable of transmitting a light, a first image position mirror disposed substantially diagonal to the object position mirror and capable of relaying the light, the first image position mirror configured to move along an axial direction, a relay mirror disposed substantially adjacent to the first image position mirror and capable of reflecting the light, the relay mirror configured to move along the axial direction, and a second image position mirror disposed substantially diagonal to the relay mirror and capable of reflecting the light.

### CROSS-REFERENCE TO RELATED APPLICATIONS

This application claims the benefit of U.S. Provisional Patent Application Ser. No. 63/603,623, filed Nov. 28, 2023, which is incorporated by reference herein in its entirety.

### BACKGROUND

### Field

Embodiments of the present disclosure generally relate to an optical system, and more specifically to an adjustable roof mirror assembly capable of improving focus of an Offner system.

### Description of the Related Art

Optical relay systems, such as the Offner relay, are widely used in the lithography field. In many embodiments, relay systems are employed to image a pattern contained on a glass plate (e.g., a mask) onto a substrate, for eventual use in semiconductor technology, for example, three-dimensional printing, display technology, and the like. Many lithography systems employ a scanning stage to continuously move a substrate while the substrate is being patterned. Moving the substrate during processing typically increases substrate production throughput, but may cause warping of the substrate. As warping may cause optical focus issues during patterning, adjusting the position of an image plane is desirable to maintain the patterning image in sharp focus. In typical relay systems, it is not feasible to move the entire projection system, and the associated illumination and alignment systems, because of their mass and the many electrical, vacuum, and coolant connections. Feasibility is further hindered when changing the focal plane position may adversely affect the alignment between the substrate and the projected image, appreciably degrading pattern overlay accuracy.

Therefore, there is a need for apparatuses and methods to adjust the position of an image plane with a relay system without degrading image quality.

### SUMMARY

The present disclosure generally includes a device. The device may include an object position mirror capable of transmitting a light, a first image position mirror disposed substantially diagonal to the object position mirror and capable of relaying the light, the first image position mirror configured to move along an axial direction, a relay mirror disposed substantially adjacent to the first image position mirror and capable of reflecting the light, the relay mirror configured to move along the axial direction, and a second image position mirror disposed substantially diagonal to the relay mirror and capable of reflecting the light.

The present disclosure generally includes a device. In an embodiment, the device may include a set of adjustable roof mirrors capable of relaying light, a first portion of the set of the adjustable roof mirrors disposed adjacent to and substantially facing a first primary mirror, and a second portion of the set of the adjustable roof mirrors disposed adjacent to and substantially facing a second primary mirror. The device may include one or more sensors capable of producing a measurement of a distance between the set of the adjustable roof mirrors and an image plane. The device may include an adjustment motor coupled to the set of the adjustable roof mirrors, the adjustment motor capable of adjusting an axial position of the set of the adjustable roof mirrors based on the measurement.

The present disclosure generally includes a method for relaying light. In an embodiment, the method generally includes measuring a distance between a set of adjustable roof mirrors and an image plane, the set of the adjustable roof mirrors capable of relaying and reflecting a light, a first portion of the set of the adjustable roof mirrors disposed adjacent to and substantially facing a first primary mirror, and a second portion of the set of the adjustable roof mirrors disposed adjacent to and substantially facing a second primary mirror. The method generally includes adjusting an axial position of the set of the adjustable roof mirrors based on the distance.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1 illustrates a schematic view of an example Offner relay system, according to embodiments described herein.

FIG. 2 illustrates a schematic view of an example Offner relay system with a shell corrector, according to embodiments described herein.

FIG. 3 illustrates a schematic view of an example Offner relay system with a beam splitter, according to embodiments described herein.

FIG. 4 illustrates an overhead view of an example roof mirror assembly, according to embodiments described herein.

FIG. 5 illustrates schematic views of an example roof mirror assembly capable of moving in an axial direction, according to embodiments described herein.

FIG. 6 illustrates a schematic view of an example Offner relay system with an example roof mirror assembly, according to embodiments described herein.

FIG. 7 is an example graph showing roof mirror assembly position relative to a maximum distortion amount, according to embodiments described herein.

FIG. 8 is an example workflow for performing a method, according to embodiments described herein.

FIG. 9 is a perspective view of a digital lithography system, according to embodiments described herein.

FIG. 10 is a schematic diagram of a lithography environment, according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure relates to an optical system, and more specifically to an adjustable roof mirror assembly capable of improving focus of an Offner system. Specifically, the adjustable roof mirror system may be adjusted to alter the focal plane of an Offner system without diminishing the accuracy of a pattern imaged at a substrate. Adjustment may occur by moving an element disposed within the Offner system, located within the optical relay.

Lithography systems employing an imaging system, such as those described herein, may implement a scanning stage to continuously move a substrate while it is being patterned. The continuous movement may increase substrate throughput, but may warp the substrate in the process. Warping may cause a focal plane of the imaging system to take a position is not optimally positioned over the surface of the substrate. Thus, it may be useful to adjust the position of the focal plane to align with an image plane, maintaining the image in sharp focus. In some embodiments, adjustment may be dynamic. Typically, it is not feasible to move an entire relay system on account of weight. Ideally, the mechanism for changing the focal plane location may be small, light in weight, and stiff so that the mechanism can withstand certain oscillation frequencies (e.g., below about 50 Hz) encountered by the imaging system. It is desirable that changing the focal plane position does not affect the alignment between the substrate and the projected image, or appreciably degrade the image quality. In the current state of the art, none of the optical elements employed in any Offner relay systems provide a practical way to adjust the focal plane position without altering the alignment between the substrate and the projected image.

Embodiments described herein provide a roof mirror assembly that addresses the inherent issues with adjusting the focal plane position of an Offner system. Embodiments may include a system with at least two mirrors having a right angle between their reflective surfaces. In one embodiment, such an arrangement forms a roof mirror assembly. The roof mirror assembly may be rigidly tied together and mounted on a scanning component (e.g., an adjustment motor, such as a servo motor) that can move the roof mirror assembly parallel to an optical axis of an Offner optical system. When positioned so no focus shift occurs, the roof mirror assembly is positioned so the image is focused halfway between each of the two mirror. This makes the final focus position co-planar with the object plane. Moving the roof-mirror assembly up or down may shift the position of the first focus and the focal position of the final image.

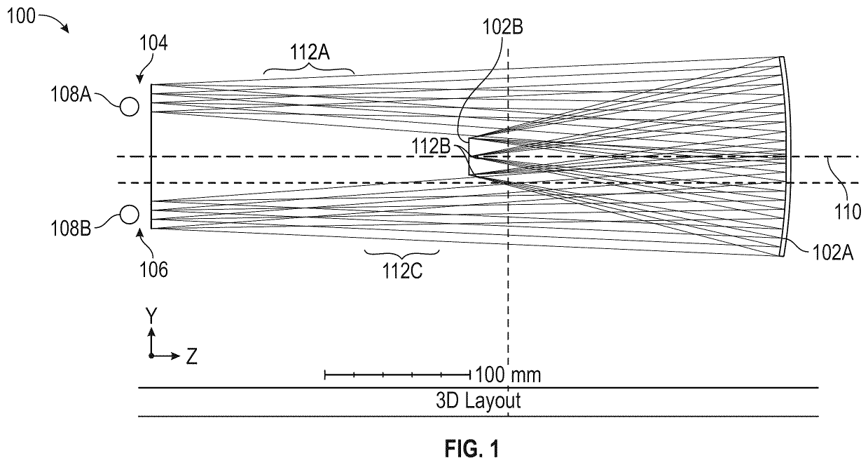

FIG. 1 depicts an example Offner relay system 100, according to certain embodiments. The system 100 includes a primary mirror 102A and a secondary mirror 102B. In some embodiments, the primary mirror 102A may be a concave mirror that is larger than the secondary mirror 102B which may be convex mirror. For example, in certain embodiments, which may be combined with other embodiments described herein, the radius of curvature of the primary mirror 102A may be about twice as large as the radius of curvature of the secondary mirror 102B. In the system 100, both mirrors 102A, 102B may be arranged so that their centers of curvature are substantially co-located along an optical axis 110 of the system 100. The system 100 also includes an object plane 104 and an image plane 106. As shown in FIG. 1, the object plane 104 and the image plane 106 are coplanar on opposite sides of the optical axis 110. A point 108A on the object plane 104 on one side of the optical axis 110 is imaged at point 108B on the image plane 106 on the other side of the optical axis. In some embodiments, light from the object plane 104 transmits as light 112A towards the primary mirror 102A and reflects off the primary mirror 102A to be incident on the secondary mirror 102B. The light reflects off the secondary mirror 102B as light 112B to be incident again on the primary mirror 102A. From the primary mirror 102A, the light reflects off the primary mirror 102A and is transmitted as light 112C toward and imaged on the image plane 106. In some embodiments, because of obscuration by the secondary mirror 102B, the object plane 104 and image plane 106, which are superimposed, may be in the shape of an annulus (donut shaped). In some embodiments, the system 100 may have a wide spectral range. In some embodiments, the image plane 106 may align with a focal plane. In some embodiments, the object plane 104 may align with a digital micro-mirror device (DMD) window and/or a DMD field.

In some embodiments, the radius of the curvature of the primary mirror 102A, the radius of the curvature of the secondary mirror 102B, the distance between the object plane 104 and the image plane 106, optical axis 110, and other values of system 100 may be pre-defined within an optical design platform. Non-limiting examples of optical design platforms include VMax, Code V, and any other suitable optical platform.

In some embodiments, the primary mirror 102A may have a clear aperture (CA) value of about 150 mm or more to about 170 mm or less, such as about 155 mm or more to about 165 mm or less, such as about 158 mm or more to about 161 mm or less, such as about 160 mm, such as about 159 mm, about 159.9 mm, and the like. In some embodiments, secondary mirror 102B may have CA value of about 15 mm or more to about 30 mm or less, such as about 20 mm or more to about 25 mm or less, such as about 23 mm, such as about 24 mm, about 23.464 mm, and the like. In some embodiments, the distance between the primary mirror 102A and the image plane 106 is about 430 mm or more to about 470 mm or less, such as 440 mm or more to about 460 mm or less, such as about 445 mm or more to about 450 mm or less, such as about 447 mm or more to about 449 mm or less, such as about 448 mm, and the like.

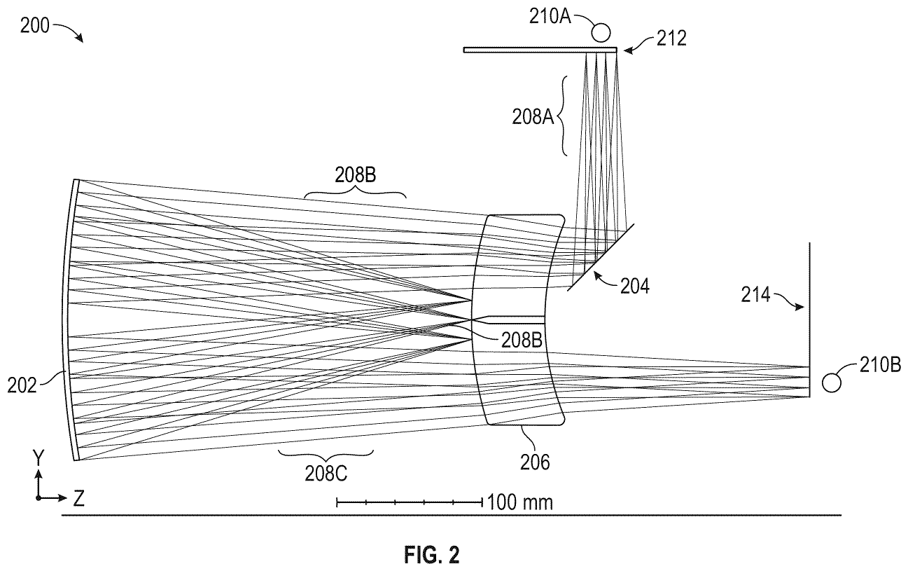

FIG. 2 is an example Offner relay system 200 having a refractive shell 206. The system 200 includes a primary mirror 202, which is a large, concave mirror. The system 200 includes a fold mirror 204 and the refractive shell 206, which may intercept the light 208B going to the primary mirror 202 and the light 208E returning from the primary mirror 202. Specifically, light 208A incident from the object plane 212 transmits towards the fold mirror 204 and through the refractive shell 206, then reflects off the primary mirror 202 to be incident on a reflective coating (not shown) of the refractive shell 206. The light 208B then reflects off the reflective coating (not shown) of the refractive shell 206 to be incident again on the primary mirror 202. Finally, the light 208C reflects off the primary mirror 202 to be transmitted through the refractive shell 206, toward and imaged on the image plane 214. Accordingly, a point 210A on the object plane 212 is imaged at point 210B on the image plane 210.

In some embodiments, the reflective coating of the refractive shell 206 may perform in a manner substantially similar to the secondary mirror 102B of FIG. 1, because an outer surface (not shown) of the refractive shell 206 has a radius of curvature similar to the secondary mirror 102B. In some embodiments, the refractive shell 206 may be a refractive corrector having a single element shell, the single element shell being formed of a glass. In some embodiments, the system 200 may have a wide spectral range. In some embodiments, the image plane 214 may align with a focal plane. In some embodiments, the object plane 212 may align with a DMD window and/or and DMD field.

In some embodiments, the primary mirror 202 may have a CA value of about 150 mm or more to about 170 mm or less, such as about 155 mm or more to about 165 mm or less, such as about 158 mm or more to about 161 mm or less, such as about 160 mm, such as about 159 mm, about 159.9 mm, and the like. In some embodiments, refractive shell 206 may have a reflective coating with a CA value of about 15 mm or more to about 30 mm or less, such as about 20 mm or more to about 25 mm or less, such as about 23 mm, such as about 24 mm, about 23.464 mm, and the like. In some embodiments, the distance between the primary mirror 202 and the image plane 210 is about 430 mm or more to about 470 mm or less, such as 440 mm or more to about 460 mm or less, such as about 445 mm or more to about 450 mm or less, such as about 447 mm or more to about 449 mm or less, such as about 448 mm, and the like.

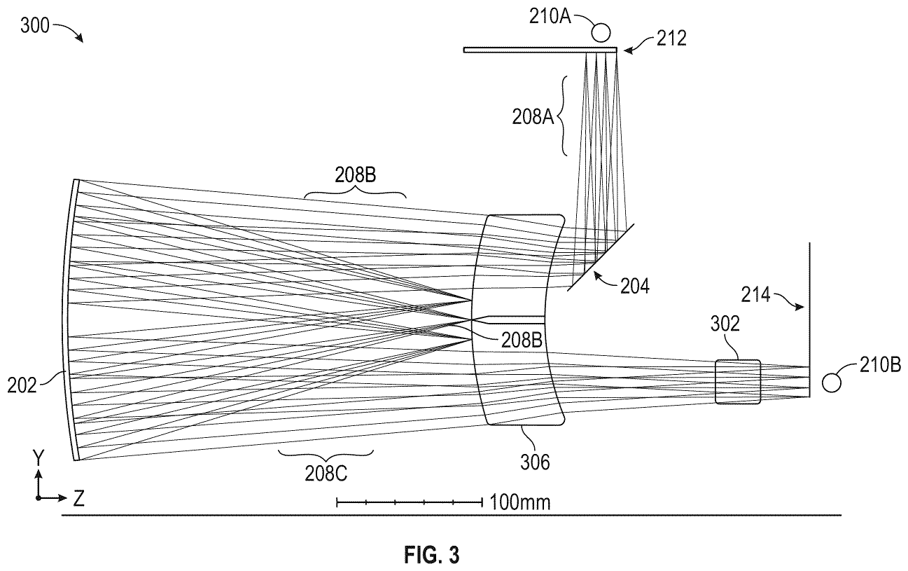

FIG. 3 is an example Offner relay system 300, incorporating the primary mirror 202, and fold mirror 204, the object plane 212, and the image plane 214 of the system 200 of FIG. 2, as well as a doublet corrector 306 and a beam splitter 302 disposed between the doublet corrector 306 and the image plane 214. The doublet corrector 306 may be positioned within the system 300 in a manner substantially similar to the position of refractive shell 206 within system 200. Light 208C reflects off the primary mirror 202 to be transmitted through the doublet corrector 306, through the beam splitter 302 and is imaged on the image plane 214. Accordingly, a point 210A on the object plane 212 is imaged at point 210B on the image plane 210. In some embodiments, the doublet corrector 306 may be a refractive corrector containing two lens elements and a gain component. In some embodiments, both a weak positive and a weak negative shell are used for doublet corrector 306 to compensate for aberration introduced by adding the beam splitter 302 to the path of the light 208 in the system 300.

In some embodiments, the beam splitter 302 may provide an image of a projected object pattern superimposed on a substrate pattern. The pattern superimposition enhances the system 300 by enabling the two patterns to align. The beam splitter may add additional aberrations, which can be corrected with the doublet corrector 306. The path of light 208 through system 300 is generally analogous to the path of light 208 though system 200. However, the path of light 208 for system 200 contains a fold mirror 204 between the object plane 212 and a refractive corrector (in system 200, the refractive shell 206), while the path of light 208 for system 300 contains a beam splitter 302 between the refractive corrector (in system 300, the doublet corrector 306) and the image plane 214. In some embodiments, the system 300 may have a wide spectral range. In some embodiments, the image plane 214 may align with a focal plane. In some embodiments, the object plane 212 may align with a DMD window and/or and DMD

### FIELD

In some embodiments, the primary mirror 202 may have a CA value of about 150 mm or more to about 170 mm or less, such as about 155 mm or more to about 165 mm or less, such as about 158 mm or more to about 161 mm or less, such as about 160 mm, such as about 159 mm, about 159.9 mm, and the like. In some embodiments, doublet corrector 306 may have a reflective coating with a CA value of about 15 mm or more to about 30 mm or less, such as about 20 mm or more to about 25 mm or less, such as about 23 mm, such as about 24 mm, about 23.464 mm, and the like. In some embodiments, the distance between the primary mirror 202 and the image plane 210 is about 430 mm or more to about 470 mm or less, such as 440 mm or more to about 460 mm or less, such as about 445 mm or more to about 450 mm or less, such as about 447 mm or more to about 449 mm or less, such as about 448 mm, and the like.

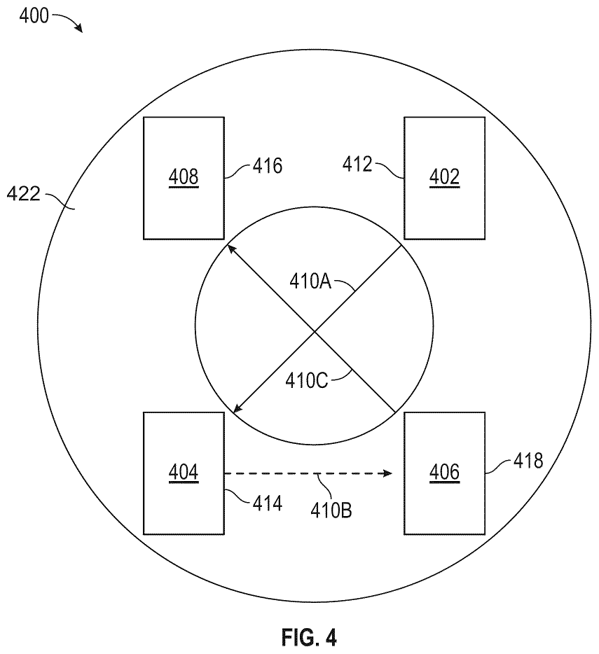

Embodiments of the present disclosure provide a roof mirror assembly. FIG. 4 illustrates an axial view of the path of a light 410 through an example roof mirror assembly 400 as implemented in a relay system (e.g., system 100, system 200, and system 300). The path of light 410 through the assembly 400 includes at least an object position 402, a first image position 404, a relay position 406, and a second image position 408. Object position 402 is diagonally opposite from the first image position 404, and the relay position 406 is diagonally opposite from the second image position 408. In an embodiment, the object position 402 is transmitted as light 410A to the first image position 404. The first image position 404 is then relayed as light 410B to the relay position 406 by the assembly 400, and then the second image position 408 diagonally opposite the relay position 406. Accordingly, to image an object (not shown) at the object position 402, light 410A is transmitted from the object position 402 diagonally to the first image position 404. Light 410B is then reflected from the first image position 404 to the relay position 406 adjacent to the first image position 404. Light 410C is then reflected from the relay position 406 diagonally to the second image position 408. In some embodiments, the object position 402 may be an object plane. In some embodiments, the second image position 408 may be an image plane and/or may align with a focal plane.

In some embodiments, the field 422 encompasses the object position 402, the first image position 404, the relay position 406, and the second image position 408. The field 422 may be disposed substantially below a first primary mirror 412, a first relay mirror 414, a second relay mirror 416, and a second primary mirror 418, such that the first primary mirror 412, the first relay mirror 414, the second relay mirror 416, and the second primary mirror 418 may reflect light transmitted from the field 422. For example, light may be transmitted from the field 422 onto the first primary mirror 412, then onto the first relay mirror 414, then onto the second relay mirror 416, then onto the second primary mirror 418, and finally back onto the field 422. The object position 402 may be disposed coaxial with the first primary mirror 412. The first image position 404 may be disposed coaxial with the first relay mirror 414. The relay position 406 may be disposed coaxial with the second relay mirror 416. The second image position 408 may be disposed coaxial with the second primary mirror 418.

In some embodiments, the first primary mirror 412 and second primary mirror 418 may be disposed above the first relay mirror 414 and the second relay mirror 416. For example, the first primary mirror 412 and second primary mirror 418 may be in a fixed position above the first relay mirror 414, the second relay mirror 416, and the field 422. In some embodiments, the first primary mirror 412 may be disposed laterally adjacent to the second primary mirror 418, laterally adjacent to the first relay mirror 414, and laterally across from the second relay mirror 416. In some embodiments, the first relay mirror 414 may be disposed laterally adjacent to the second relay mirror 416, laterally adjacent to the second primary mirror 418, and laterally across from the first primary mirror 412. In some embodiments, the second relay mirror 416 may be disposed laterally adjacent to the first primary mirror 412, laterally adjacent to the first relay mirror 414, and laterally across from the second primary mirror 418. In some embodiments, the second primary mirror 418 may be disposed laterally adjacent to the first primary mirror 412, laterally adjacent to the first relay mirror 414, and laterally across from the second relay mirror 416.

In some embodiments, assembly 400 utilizes the field 422 of the Offner system. In such embodiments, the field 422 may be in the shape of an annulus (e.g., a donut) and cover a much larger area than typical for most applications (including applications in the field of lithography). For example, in an embodiment, the field size of a digital lithography system employing a DMD (e.g., a DMD field) may be about 10 mm or more to about 25 mm or less in length, such as about 18 mm or more to about 22 mm or less in length, such as about 19 mm in length, about 19.3536 mm in length, and the like. The DMD field would be about 5 mm or more to about 20 mm or less in width, such as about 10 mm or more to about 14 mm of less in width, such as about 12 mm in width, about 12.096 mm in width, and the like.

On the other hand, in some embodiments, the field 422 of the Offner system used to image such a substrate may be shaped in an annulus with an inner radius and an outer radius. The inner radius of the annulus may be about 20 mm or more to about 40 mm or less, such as about 25 mm or more to about 35 mm or less, such as about 26 mm or more to about 28 mm or less, such as about 27 mm, about 27.1 mm, and the like. The outer radius of the annulus may be about 35 mm or more to about 55 mm or less, such as about 40 mm or more to about 50 mm or less, such as about 44 mm or more to about 47 mm or less, such as about 45 mm, about 45.5 mm, and the like. The inner radius may be determined by a desire to mitigate vignetting by the secondary mirror and the outer radius may be determined by the number and size of the objects to be imaged. Accordingly, in some embodiments, the object position 402, the first image position 404, the relay position 406, and the second image position 408 may be disposed within the outer perimeter of the field 422.

Advantageously, the image quality provided by an Offner-type relay allows for expanding the relay field size to accommodate multiple DMD sized fields. For example, in some implementations, depending on the desired lithography field size, the aberration correction may be enhanced after two passes through the assembly 400.

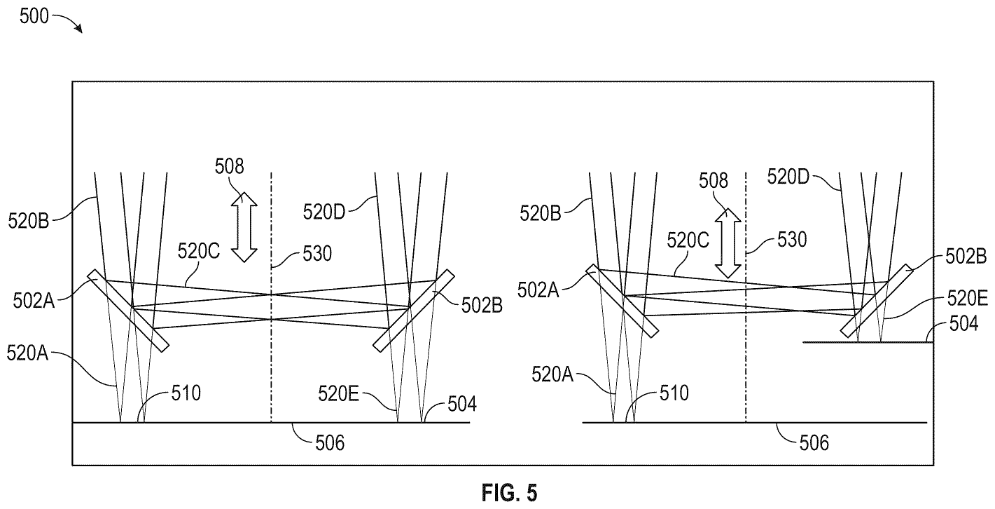

In some embodiments, the assembly 400 may intercept light that has passed through the optical elements of system 100, 200, 300 before it is brought to focus. The intercepted light is directed back though the system 100, 200, 300 and is reimaged in a position laterally displaced from the object position. As shown in FIG. 5, moving the assembly 400 parallel to an optical axis of the system 100, 200, 300 may change a focal position of the image without changing the lateral position.

FIG. 5 illustrates an example roof mirror assembly 500, according to certain embodiments. Assembly 500 includes two flat mirrors 502A, 502B, coupled in a rigid manner such that assembly 500 is capable of movement parallel to an optical axis 530 to shift a focal plane 504 disposed over a top surface of a substrate 506 in an axial direction 508. In an embodiment, the axial direction 508 is parallel with the optical axis 530 and normal to the top surface of the substrate 506. In some embodiments, assembly 500 may be configured in a manner similar to assembly 400 of FIG. 4 as described above. For example, in an embodiment, motion of the mirrors 502A, 502B of about 1 mm in the axial direction 508 corresponds to motion of the focal plane 504 of about 2 mm in the axial direction 508. In some embodiments, the assembly 500 provides for traversing the Offner system twice without interference between the different images. When used for only a single traverse, the magnification of the Offner system is −1, indicating that the image is really a mirror image of the object. In contrast, by implementing the assembly 500, dual-traverse of light through the Offner system results in a magnification ratio of +1. As a result, an image plane may be on the same side as, but not overlapping with, an object plane, substantially improving focusing ability of a system with the assembly 500 implemented. In some embodiments, focal plane 504 may be an image plane.

As shown in FIG. 5, the two flat mirrors 502A, 502B are positioned substantially above the substrate 506. In some embodiments, the flat mirrors 502A, 502B may each disposed about 45 degrees relative to the optical axis 530, and mirror each other across the optical axis 530. Flat mirror 502A may be laterally adjacent to flat mirror 502B and may be capable of reflecting light from a primary mirror (not shown, but may be understood with reference to primary mirrors 412, 418) to a flat mirror 502B. Similarly, flat mirror 502B may be laterally adjacent to flat mirror 502A and may be capable of reflecting light from a primary mirror (not shown, but may be understood with reference to primary mirrors 412, 418) to flat mirror 502A. The flat mirrors 502A, 502B may be adjustable over the substrate 506 in the axial direction 508. The axial direction 508 can be substantially vertical and normal to the top surface of the substrate 506.

In some embodiments, the flat mirror 502B may be disposed over a focal plane 504. The focal plane 504 may move in an axial direction 508 based on the movement of the flat mirrors 502A, 502B. The flat mirrors 502A, 502B may move along the axial direction 508 at the same time. For example, if flat mirror 502A moves a certain distance (not shown) in the axial direction 508, flat mirror 502B moves substantially the same vertical distance in the axial direction 508. In certain embodiments, light 520B propagates from object plane 510 (with may be further understood with reference to at least object position 402 and object plane 602) to a first primary mirror (not shown, may be understood with reference to at least primary mirrors 412, 418). Reflecting off the first primary mirror, light 520B is transmitted to flat mirror 502A. Light 520C reflects off flat mirror 502A and is relayed to flat mirror 502B. Light 520D reflects off flat mirror 502B towards a second primary mirror (not shown, but may be understood with reference to at least primary mirrors 412, 418). Light 520E reflects off the second primary mirror onto the focal plane 504.

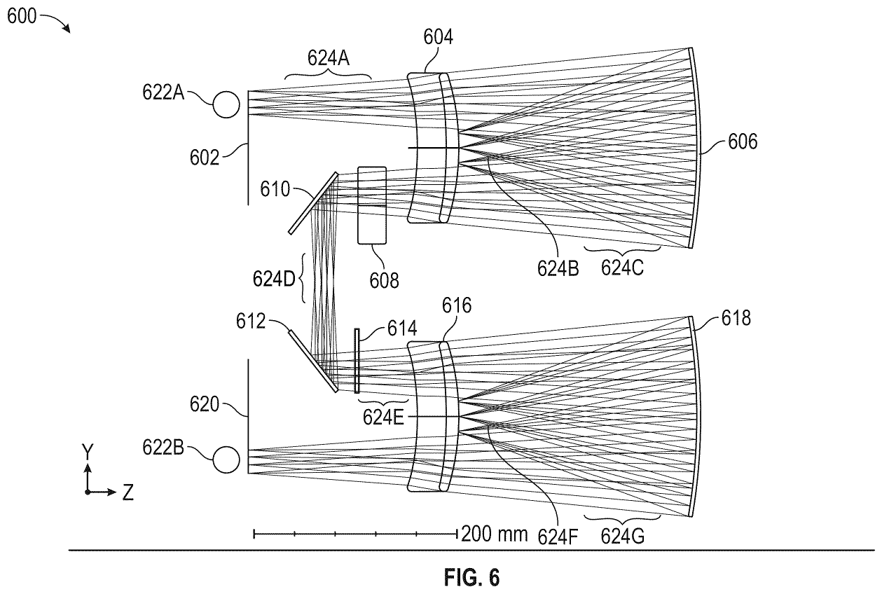

FIG. 6 is an example Offner relay system 600, incorporating features of the assembly 400 of FIG. 4 and the assembly 500 of FIG. 5. The system 600 includes a DMD object plane 602, a first shell 604, a first primary mirror 606, a first beam splitter 608, a first roof mirror 610, a second roof mirror 612, a second beam splitter 614, a second shell 616, a second primary mirror 618, and an image plane 620. A point 622A on the object plane 602 is imaged at point 622B on the image plane 620 (e.g., with a magnification ratio of +1). Light 624A incident from the object plane 602 transmits towards the first primary mirror 606 and through the shell 604, then reflects off the primary mirror 606 to be incident on the shell 604. The light 624B then reflects off the shell 604 to be incident again on the first primary mirror 606. The light 624C reflects off the primary mirror 606 to be transmitted through the shell 604, through the beam splitter 608, toward the first roof mirror 610. Light 624D is reflected off the first roof mirror 610 and relayed to the second roof mirror 612. Light 624E incident from the second roof mirror 612 transmits towards the second primary mirror 618, through the second beam splitter 614, and through the shell 616, then reflects off the second primary mirror 618 to be incident on the shell 616. The light 624F then reflects off the shell 616 to be incident again on the primary mirror 618. The light 624G reflects off the primary mirror 618 to be transmitted through the shell 616, toward the image plane 620. Accordingly, a point 622A on the object plane 602 is imaged at point 622B on the image plane 620.

In some embodiments, the Z-axis can be a vertical axis, while the Y-axis can be a lateral axis. In some embodiments, the Z-axis can be a vertical axis, while the Y-axis can be a lateral axis. On the Z-axis, the first primary mirror 606 and the second primary mirror 618 may be positioned above all other features of the system 600. On the Y-axis, the first primary mirror 606 and the second primary mirror 618 may be laterally adjacent to each other. Shell 604 may be disposed at least partially above the beam splitter 608 and the first roof mirror 610. Shell 604 may be disposed below the first primary mirror 606. Shell 604 may be disposed above the object plane 602 and the point 622A. Shell 604 may be disposed laterally adjacent to shell 616. Shell 616 may be disposed at least partially above the beam splitter 614 and the second roof mirror 612. Shell 604 may be disposed below the second primary mirror 618. Shell 604 may be disposed above the image plane 620 and the point 622B. In some embodiments, the shell 604 and the shell 616 may be doublet correctors (e.g., doublet corrector 306 of FIG. 3).

Beam splitter 608 may be at least partially disposed below shell 604. Beam splitter 608 may be disposed below the first primary mirror 606. Beam splitter 608 may be disposed substantially above the first roof mirror 610. Beam splitter 608 may be at least partially disposed above the object plane 602. Beam splitter 608 may be laterally adjacent to beam splitter 614. Beam splitter 614 may be at least partially disposed below shell 616. Beam splitter 614 may be disposed below the second primary mirror 618. Beam splitter 614 may be disposed substantially above the second roof mirror 612. Beam splitter 614 may be at least partially disposed above the image plane 620. Beam splitter 614 may be laterally adjacent to beam splitter 608.

The first roof mirror 610 may be substantially disposed below the first primary mirror 606 and the beam splitter 608. The first roof mirror 610 may be at least partially disposed below the shell 604. The first roof mirror 610 may be at least partially disposed above the object plane 602. The first roof mirror 610 may be disposed laterally adjacent to the second roof mirror 612. The second roof mirror 612 may be substantially disposed below the first primary mirror 618 and the beam splitter 614. The second roof mirror 612 may be at least partially disposed below the shell 616. The second roof mirror 612 may be at least partially disposed above the image plane 620. The second roof mirror 612 may be disposed laterally adjacent to the first roof mirror 610.

On the Z-axis, the object plane 602 and the image plane 620 may be disposed above all other features of the system 600, except for points 622. Point 622A may be considered to be substantially flush with the object plane 602, and point 622B may be considered to be substantially flush with the image plane 620. On the Y-axis, the object plane 602 and the image plane 620 may be laterally adjacent to each other. In embodiments where the first roof mirror 610 and the second roof mirror 612 are moved in an axial direction (not shown, may be understood with reference to at least axial direction 508 of FIG. 5), the image plane 620 may be laterally adjacent to each other, and may either be alongside or above the object plane 602.

In some embodiments, the roof mirrors 610/612 of system 600 provide a broad range of wavelengths over which the focus may be adjusted. Adjustments may be implemented to configure a narrow range of wavelengths used for exposure (e.g., about 0.3 μm to about 0.5 μm), and broad range of wavelengths used for aligning and focusing the DMD pattern to the substrate pattern (e.g., about 0.4 μm to about 0.8 μm).

In some embodiments, the first primary mirror 606 and/or the second primary mirror 618 may have a CA value of about 150 mm or more to about 170 mm or less, such as about 155 mm or more to about 165 mm or less, such as about 158 mm or more to about 161 mm or less, such as about 160 mm, such as about 159 mm, about 159.9 mm, and the like. In some embodiments, the shell 604 and/or the shell 616 may have a reflective coating with a CA value of about 15 mm or more to about 30 mm or less, such as about 20 mm or more to about 25 mm or less, such as about 23 mm, such as about 24 mm, about 23.464 mm, and the like. In some embodiments, the distance between the first primary mirror 606 and/or the second primary mirror 618 and the image plane 620 is about 430 mm or more to about 470 mm or less, such as 440 mm or more to about 460 mm or less, such as about 445 mm or more to about 450 mm or less, such as about 447 mm or more to about 449 mm or less, such as about 448 mm, and the like. In some embodiments, the image plane 620 may align a focal plane, or be made to align with the focal plane by moving the first roof mirror 610 and the second roof mirror 612 in an axial direction.

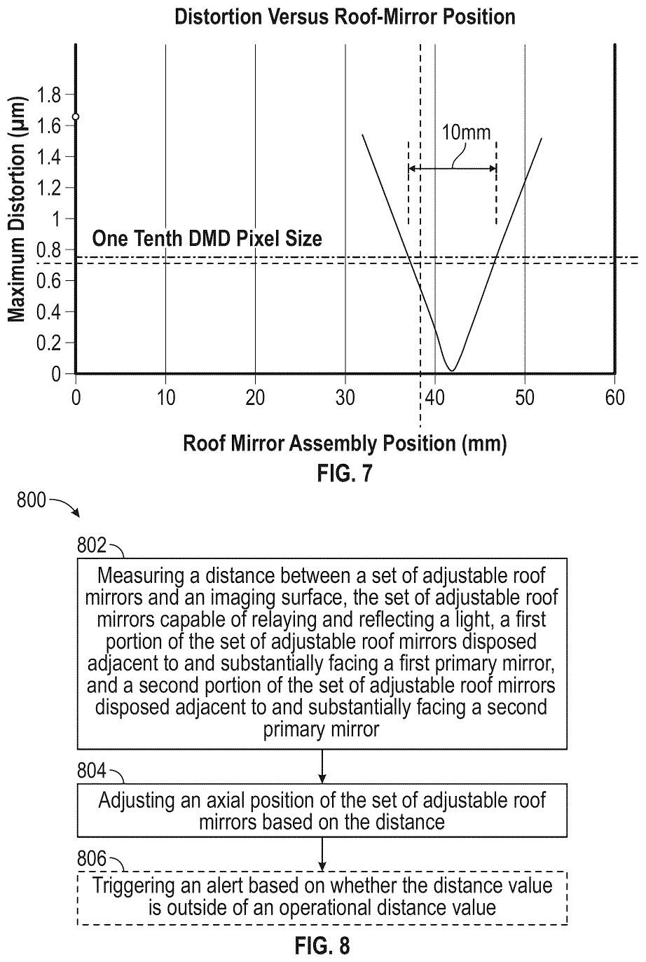

FIG. 7 illustrates an example graph showing resultant distortion as a function of roof mirror assembly position, according to certain embodiments. In the non-limiting example, numerical aperture (NA) of the system was about 0.05 and the maximum distortion amount was set at about 0.75 micron. This limited the maximum focus correction range to about 10 mm. Where the example NA of the system is about 0.05 to about 0.07 (e.g., 0.058), moving the roof mirrors 610, 612 of system 600 over a range of about 10 mm did not have an appreciable effect on the root mean squared (RMS) optical path difference (OPD). However, as shown in FIG. 7, the maximum distortion may increase linearly with the amount of defocus. In certain embodiments, setting a minimum acceptable distortion to one tenth of a DMD pixel size (e.g., about 0.75 or more to about 0.76 or less) may help to set a limit on the allowable roof motion to about 10 mm, which would vary the focus adjustment range by about 20 mm. In certain embodiments, focus range may vary according to at least NA, field size, and spectral range of an Offner relay.

FIG. 8 is an example workflow 800 for relaying light, according to certain embodiments described herein. At operation 802, one or more sensors measure a distance value between a set of adjustable roof mirrors and an imaging surface. In some embodiments, the set of the adjustable roof mirrors may be capable of relaying and reflecting light. A first portion of the set of the adjustable roof mirrors may be disposed adjacent to and substantially face a first primary mirror. A second portion of the set of the adjustable roof mirrors may be disposed adjacent to and substantially face a second primary mirror.

In some embodiments, the sensors may be optical sensors, sonic sensors, or air gauge sensors. The sensors may be disposed in any position suitable to measure the distance value. The roof mirrors utilized in operation 802 may be part a roof mirror assembly. In some embodiments, the focused light from operation 802 enables a focal plane of a relay system to be oriented above a substrate. For example, in some embodiments, a focal plane of the relay system is disposed directly above a substrate. This focusing mechanism enable improved substrate patterning, as described above. Operation 802 may be further understood with respect to FIGS. 4, 5, and 6.

At operation 804, an axial position of the set of adjustable mirrors is adjusted based on the distance measured in operation 802. In some embodiments, an adjusting component (e.g., an adjustment motor, such as a servo motor) may be used to adjust the axial position of the set of adjustable roof mirrors. For example, the adjusting component may be a servo system that may move and control a roof mirror axial position such that an image plane is aligned with a top surface of the substrate. At optional operation 806, an alert system triggers an alert based on whether the distance value is outside of an operational distance value.

In some embodiments, the workflow 800 enables movement of the roof mirror assembly in a direction parallel to an axis of an Offner optical system. By encompassing the roof mirror assembly within the Offner optical system, the image forming light is transmitted twice through the Offner system, and focuses a second time in a plane congruent with an object plane or displaced therefrom, depending on the axial position of the roof mirror assembly. The lateral distance between the object plane and the image plane may depend on the separation between the two roof mirrors and may not change as they are moved parallel to the optical axis of the Offner relay system.

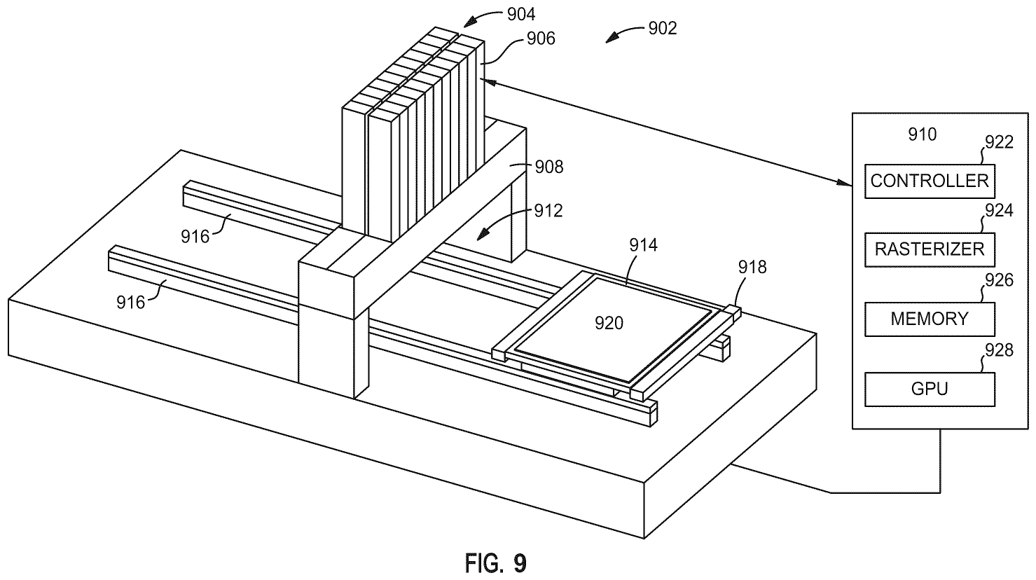

FIG. 9 is a perspective view of a digital lithography device 902, such as a digital lithography system, that may benefit from embodiments described herein. The digital lithography device 902 includes a stage 914, a processing unit 904, and one or more image projection systems (IPSs) 906. The processing unit 904 is configured to expose a photoresist in the digital lithography process using the one or more IPSs 906. In some embodiments, the one or more IPSs 906 may utilize or be implemented with an Offner relay systems and/or the adjustable mirrors/roof mirror assemblies described herein to enhance the image projected by the one or more IPSs 906 on to a substrate 920 supported by the stage 914. The stage 914 is supported by a pair of tracks 916 and is operable to move along the pair of tracks 916. An encoder 918 is coupled to the stage 914 in order to provide information of the location of the stage 914 to a lithography server 910. The lithography server 910 includes, but is not limited to a controller 922, a rasterizer 924, a memory 926, and a GPU 928.

The controller 922 is generally designed to facilitate the control and automation of the processing techniques described herein. The controller 922 may be coupled to or in communication with the processing unit 904, the stage 914, and the encoder 918. The processing unit 904 and the encoder 918 may provide information to the controller 922 regarding the substrate processing and the substrate aligning. For example, the processing unit 904 may provide information to the controller 922 to alert the controller 922 that substrate processing has been completed. The controller 922 facilitates the control and automation of a digital lithography process, such as a digital lithography process based on a virtual mask file provided to the lithography server 910.

The controller 922 retrieves and executes programing data stored in the memory 926 and coordinates operations of other system components. Similarly, the controller 922 stores and retrieves application data residing in the memory 926. The controller 922 may be one or more central processing units (CPUs). Alternatively, or additionally, the controller 922 may be one or more application specific software programs.

The memory 926 may store instructions and logic to be executed by the controller 922. Further, the memory 926 may be one or more of a random access memory (RAM) and a non-volatile memory (NVM). The NVM may be a hard disk, a network attached storage (NAS), and a removable storage wafer, among others.

The substrate 920 comprises any suitable material, for example, glass, which can used as part of a flat panel display. In other embodiments, the substrate 920 could be a wafer used in advanced packaging (AP) or similar applications in semiconductor manufacturing. The substrate 920 has a film layer to be patterned thereon, such as by pattern etching thereof, and a may have photoresist formed on the film layer to be patterned, which is sensitive to electromagnetic radiation, for example UV or deep UV “light”. A positive photoresist includes portions of the photoresist, when exposed to radiation, are respectively soluble to a photoresist developer applied to the photoresist after the pattern is written into the photoresist using the electromagnetic radiation. A negative photoresist includes portions of the photoresist, when exposed to radiation, will be respectively insoluble to photoresist developer applied to the photoresist after the pattern is written into the photoresist using the electromagnetic radiation. The chemical composition of the photoresist determines whether the photoresist is a positive photoresist or negative photoresist. Examples of photoresists include, but are not limited to, at least one of diazonaphthoquinone, a phenol formaldehyde resin, poly(methyl methacrylate), poly(methyl glutarimide), and SU-8. After exposure of the photoresist to the electromagnetic radiation, the resist is developed to leave a patterned photoresist on the underlying film layer. Then, using the patterned photoresist, the underlying thin film is pattern etched through the openings in the photoresist to form a portion of the electronic circuitry of the display panel or advanced packaging wafer.

The processing unit 904 and one or more IPSs 906 are supported by the support 908 such that the processing unit 904 and one or more IPSs 906 straddle the pair of tracks 916. The support 908 provides an opening 912 for the pair of tracks 916 and the stage 914 to pass under the processing unit 904. The processing unit 904 is a pattern generator configured to receive the virtual mask file from the lithography server 910 and expose the photoresist in the digital lithography process using the one or more image projection systems (IPS) 906 operable to project write beams of electromagnetic radiation to the substrate 920. The pattern generated by the processing unit 904 is projected by the image projection systems 906 to expose the photoresist of the substrate 920 to the mask pattern that is written into the photoresist.

In one embodiment, which can be combined with other embodiments described herein, each image projection system 906 includes a spatial light modulator to modulate the incoming light to create the desired image. Each spatial light modulator includes a plurality of electrically addressable elements that may be controlled individually. Each electrically addressable element may be in an “ON” position or an “OFF” position based on the virtual mask file provided to the digital lithography device 902. When the light reaches the spatial light modulator, the electrically addressable elements that are in the “ON” position project a plurality of write beams to a projection lens (not shown). The projection lens then projects the write beams to the substrate 920. The electrically addressable elements include, but are not limited to, digital micro-mirrors, liquid crystal displays (LCDs), liquid crystal over silicon (LCoS) wafers, ferroelectric liquid crystal on silicon (FLCoS) wafers, microshutters, microLEDs, VCSELs, liquid crystal displays (LCDs), or any solid state emitter of electromagnetic radiation.

The rasterizer 924, in some embodiments comprises one or more rasterizer computation engines and in embodiments, one or more spatial light modulator (SLM) arrays. In alternate embodiments, SLM arrays may comprise one or more digital micro-mirror (DMD) wafers, microLED, VCSEL, and/or LCD arrays, or other type of spatial light modulators. The rasterizer 924 may include a rasterizer computation engine which includes one or more field programmable gate arrays (FPGAs), graphics processing units (GPUs), a combination of FPGAs and GPUs, or other processing hard/firmware capable of converting data in an image format to a format understandable by a DMD.

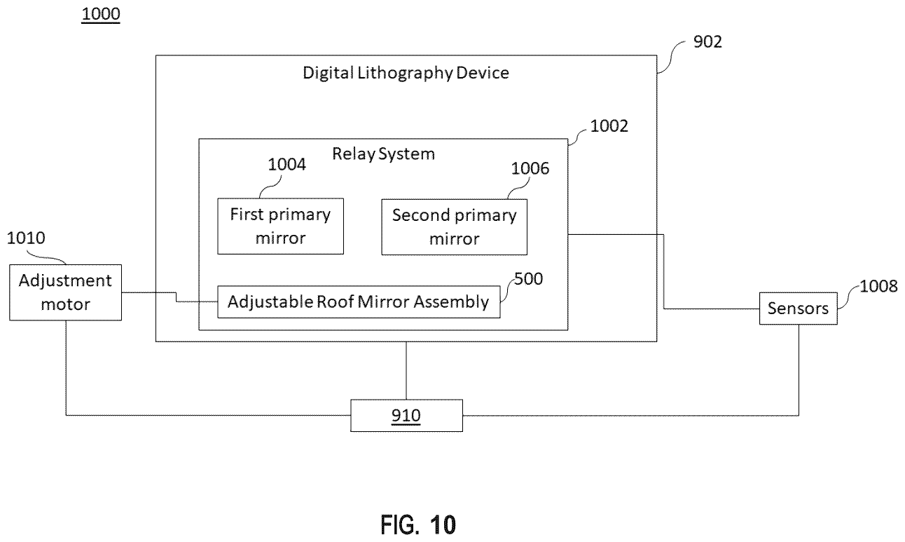

FIG. 10 is a schematic diagram of a digital lithography environment 1000, according to certain embodiments. As shown, the lithography environment 1000 includes, but is not limited to, the digital lithography device 902 having an imaging system in which the adjustable roof mirror assembly 500 is implemented in a relay system 1002. As such, the digital lithography device 902 includes the relay system 1002 having a first primary mirror 1004, a second primary mirror 1006, and incorporating the adjustable roof mirror assembly 500 as described above.

The lithography environment 1000 also includes sensors 1008 that provide for measuring a distance between the adjustable roof mirror assembly 500 and an imaging surface as discussed above in operation 802 of workflow 800, as well as an adjustment motor 1010 for moving the adjustable roof mirror assembly 500 based on the distance measured by the sensors 1008. In some embodiments, as discussed above, the adjustment motor 1010 may be used to move the roof mirror assembly 500 to shift a focal plane such that the image plane is aligned with a top surface of a substrate disposed in the digital lithography device. Adjusting the roof mirror assembly 500 to shift the focal plane in turn provides a focusing mechanism that enables improved substrate patterning, as described above.

Embodiments of the present disclosure enhance current optical systems by enabling adjustment of a focal plane without diminishing the accuracy of a pattern imaged at a substrate. Accordingly, embodiment of embodiments described herein may increase both the accuracy and precision of pattern imaging onto a substrate.

While this specification contains many specific embodiment details, these should not be construed as limitations on the scope of what may be claimed, but rather as descriptions of features that may be specific to particular embodiments. Certain features that are described in this specification in the context of separate embodiments may also be implemented, in combination, in a single embodiment. Conversely, various features that are described in the context of a single embodiment may also be implemented in multiple embodiments, separately, or in any suitable sub-combination. Moreover, although previously described features may be described as acting in certain combinations and even initially claimed as such, one or more features from a claimed combination may, in some embodiments, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional) to achieve desirable results. In certain circumstances, multitasking or parallel processing (or a combination of multitasking and parallel processing) may be advantageous and performed as deemed appropriate.

Moreover, the separation or integration of various system modules and components in the previously described embodiments should not be understood as requiring such separation or integration in all embodiments. It should be understood that the described program components and systems may generally be integrated together in a single software product or packaged into multiple software products.

Accordingly, the previously described example embodiments do not define or constrain the present disclosure. Other changes, substitutions, and alterations are also possible without departing from the spirit and scope of the present disclosure.

While the various steps in an embodiment method or process are presented and described sequentially, one of ordinary skill in the art will appreciate that some or all of the steps may be executed in different order, may be combined or omitted, and some or all of the steps may be executed in parallel. The steps may be performed actively or passively. The method or process may be repeated or expanded to support multiple components or multiple users within a field environment. Accordingly, the scope should not be considered limited to the specific arrangement of steps shown in a flowchart or diagram.

Unless defined otherwise, all technical and scientific terms used have the same meaning as commonly understood by one of ordinary skill in the art to which these systems, apparatuses, methods, processes and compositions belong.

In this disclosure, the terms “top”, “bottom”, “side”, “above”, “below”, “up”, “down”, “upward”, “downward”, “horizontal”, “vertical”, and the like do not refer to absolute directions. Instead, these terms refer to directions relative to a nonspecific plane of reference. This non-specific plane of reference may be vertical, horizontal, or other angular orientation.

The singular forms “a,” “an,” and “the” include plural referents, unless the context clearly dictates otherwise. Within a claim, reference to an element in the singular is not intended to mean “one and only one” unless specifically so stated, but rather “one or more.” Unless specifically stated otherwise, the term “some” refers to one or more.

Embodiments of the present disclosure may suitably “comprise”, “consist” or “consist essentially of” the limiting features disclosed, and may be practiced in the absence of a limiting feature not disclosed. As used here and in the appended claims, the words “comprise,” “has,” and “include” and all grammatical variations thereof are each intended to have an open, non-limiting meaning that does not exclude additional elements or steps.

“Optional” and “optionally” means that the subsequently described material, event, or circumstance may or may not be present or occur. The description includes instances where the material, event, or circumstance occurs and instances where it does not occur.

As used, the term “determining” encompasses a wide variety of actions. For example, “determining” may include calculating, computing, processing, deriving, investigating, looking up, for example, looking up in a table, a database or another data structure, and ascertaining. Also, “determining” may include receiving, for example, receiving information, and accessing, for example, accessing data in a memory. Also, “determining” may include resolving, selecting, choosing, and establishing.

When the word “approximately” or “about” are used, this term may mean that there may be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

As used, terms such as “first” and “second” are arbitrarily assigned and are merely intended to differentiate between two or more components of a system, an apparatus, or a composition. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is envisioned under the scope of the various embodiments described.

Although only a few example embodiments have been described in detail, those skilled in the art will readily appreciate that many modifications are possible in the example embodiments without materially departing from the disclosed scope as described. Accordingly, all such modifications are intended to be included within the scope of this disclosure as defined in the following claims. In the claims, means-plus-function clauses are intended to cover the structures described as performing the recited function and not only structural equivalents, but also equivalent structures. For example, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f), for any limitations of any of the claims, except for those in which the claim expressly uses the words ‘means for’ together with an associated function.

The following claims are not intended to be limited to the embodiments provided but rather are to be accorded the full scope consistent with the language of the claims.

What is claimed is:

1. A device, comprising:
an object position mirror capable of transmitting a light;
a first image position mirror disposed substantially diagonal to the object position mirror and capable of relaying the light, the first image position mirror configured to move along an axial direction;
a relay mirror disposed substantially adjacent to the first image position mirror and capable of reflecting the light, the relay mirror configured to move along the axial direction; and
a second image position mirror disposed substantially diagonal to the relay mirror and capable of reflecting the light.

2. The device of claim 1, wherein:
the object position mirror is disposed across from and substantially facing an object plane; and
the second image position mirror is disposed across from and substantially facing an image plane.

3. The device of claim 2, the device further comprising:
a field of view (FOV); and
a focal plane disposed substantially parallel to the FOV.

4. The device of claim 3, wherein the FOV is an annulus having an inner radius and an outer radius.

5. The device of claim 4, wherein the inner radius is between about 20 mm and about 40 mm and the outer radius is between about 35 mm and about 55 mm.

6. The device of claim 3, wherein the focal plane is configured for adjustment in the axial direction, based on a movement of the first image position mirror and the relay mirror, the adjustment capable of disposing the focal plane substantially parallel to the FOV.

7. The device of claim 6, wherein the adjustment has a first range of focus of about 20 millimeters (mm), and a second range of movement of about 10 mm.

8. The device of claim 1, wherein the object position mirror is a fold mirror, the first image position mirror is a first roof mirror, and the relay mirror is a second roof mirror.

9. A device, comprising:
a set of adjustable roof mirrors capable of relaying light, a first portion of the set of the adjustable roof mirrors disposed adjacent to and substantially facing a first primary mirror, and a second portion of the set of the adjustable roof mirrors disposed adjacent to and substantially facing a second primary mirror;
one or more sensors capable of producing a measurement of a distance between the set of the adjustable roof mirrors and an image plane; and
an adjustment motor coupled to the set of the adjustable roof mirrors, the adjustment motor capable of adjusting an axial position of the set of the adjustable roof mirrors based on the measurement.

10. The device of claim 9, further comprising:
a first refractive corrector disposed substantially between the first primary mirror and the first portion of the set of the adjustable roof mirrors; and
a second refractive corrector disposed substantially between the second portion of the set of the adjustable roof mirrors and the second primary mirror.

11. The device of claim 10, wherein the first refractive corrector comprises at least one of a first refractive shell or a first doublet corrector, and wherein the second refractive corrector comprises at least one of a second refractive shell or a second doublet corrector.

12. The device of claim 10, further comprising:
a first beam splitter disposed substantially between the first refractive corrector and the first portion of the set of the adjustable roof mirrors; and
a second beam splitter disposed substantially between the second portion of the set of the adjustable roof mirrors and the second refractive corrector.

13. The device of claim 9, wherein the set of the adjustable roof mirrors are configured to move along an axial direction.

14. The device of claim 13, the device further comprising:
a field of view (FOV); and
a focal plane disposed substantially parallel to the FOV.

15. The device of claim 14, wherein the FOV is a circular annulus having an inner radius and an outer radius.

16. The device of claim 15, wherein the inner radius is between about 20 mm and about 40 mm and the outer radius is between about 35 mm and about 55 mm.

17. The device of claim 14, wherein the focal plane is configured for an adjustment in the axial direction, based on a movement of the set of the adjustable roof mirrors.

18. The device of claim 17, wherein the adjustment has a first range of focus of about 20 mm, and a second range of movement of about 10 mm.

19. The device of claim 9, wherein the one or more sensors comprise at least one of:
one or more optical sensors;
one or more sonic sensors; and
one or more air gauge sensors.

20. The device of claim 9, wherein the one or more sensors comprise at least one of adjustment motor comprises a servo system.

21. A method for relaying light, comprising:
measuring a distance between a set of adjustable roof mirrors and an image plane, the set of the adjustable roof mirrors capable of relaying and reflecting a light, a first portion of the set of the adjustable roof mirrors disposed adjacent to and substantially facing a first primary mirror, and a second portion of the set of the adjustable roof mirrors disposed adjacent to and substantially facing a second primary mirror; and
adjusting an axial position of the set of the adjustable roof mirrors based on the distance.

22. The method of claim 21, further comprising:
triggering an alert based on whether the distance is outside of an operational distance value.
